(19) United States
(12) Patent Application Publication
(10) Pub. No.: US 2015/0206363 A1
(43) Pub. Date: Jul. 23, 2015

(54) HIERARCHICAL CODE LOCKING SYSTEM

(71) Applicant: Aron TEVYOWITZ, Jerusalem (IL)

(72) Inventor: Aron Tevyowitz, Jerusalem (IL)

(21) Appl. No.: 14/433,134

(22) PCT Filed: Nov. 4, 2013
(86) PCT No.: PCT/IL2013/050902

§ 371 Date: Apr. 2, 2015

(30) Foreign Application Priority Data
Nov. 4, 2012 (IL) 222847

(51) Int. Cl. G07C 9/00

(52) U.S. Cl. CPC G07C 9/00015; G07C 2209/04

(57) ABSTRACT

The invention provides a method that enables more efficient use of a code locking system, by hierarchy of codes. In order to implement this method existing code locking systems can be used by adjusting their software. It is recommended that the system will include a screen. All operations can be done in the code locking system itself without the need for external systems. So that all operations can be done in the same way that users with the system in the normal use. But you can also use external systems.

The method is to allow anyone who has an access code to the protected place to create underneath levels and codes according to the needs, regardless of how many levels above him or of who has created his code. From any code (at any level) can be created separate and different chain of levels and codes, and should be no parallel between the amount of levels and codes that result from the various codes, even if they are at the same level and result from the same code.

The codes are determined by who creates or modifies it, so that any code can be different from each other. And it also possible to generate a reset code and the user will determine the code itself.

Anyone that creates codes or levels can limit the codes and the levels below it in the possibility to create levels and codes in general, or partially. And can also limit the code in time, distance, number of operations, or any other restriction. Each level or code are subject to change or cancellation by the codes above them. It is possible to cancel or change even the higher-level code or to add code above or parallel to it.

The hierarchy of this system does not have to be a hierarchy of options of actions and it can be a hierarchy of control only.

It is possible to limit codes at higher levels with limitations that will not apply to the codes beneath them. And it is possible to limit level or code and allow them to create levels and codes below them that will not be limited by the same limitations. And also to generate code that its only action is to create another code below it, and the code that it creates may not be limited by any limitation.

### BACKGROUND

Combinational code locking systems are used frequently to control the access to protected systems such as cars, homes, safes, internet sites. Typically there is a fixed code, the user needs to type the code to unlock the system and get access to it. For example, to turn on a car the user needs to type in the code.

Usually is difficult to change the fixed code. In certain cases, e.g. cars, changing the code requires a technician. Therefore, the code is not changed which makes it easy to steal the car.

It is often the case that certain equipment, e.g. a company leased car, which several people will be allowed to use. It is important for tracking to know which person has used the car at a specific time-so a separate code needs to be given per person. There may also be several levels of usage permission. For example, a person may be allowed to drive a car, but not to fill the gas, or may be limited to a certain mileage. If a computer system in an office is used by many employees and one of them is leaving—they all will have to change the access code.

There needs to be a secure system with several levels and/or multiple users, with a easy control system.

This cannot be achieved by the single code system used today.

The present invention offers a hierarchy of security code combinations with the ability to change any code in the hierarchy by the upper levels.

The hierarchy will be achieved by forming a pyramid of code locks, where each level is controlling the level below it.

The idea to create hierarchical code system appears already in the following patents:
1. WO8702160 (wo1987002160. wo198702160)
2. GB2402840
3. WO2004070550 (U.S. Pat. No. 7,061,367)
4. U.S. Pat. No. 5,021,776

But patent no. WO8702160 deals with a completely different type of hierarchy (Accordingly, it deals with solution an entirely different problem—Access to personal medical file). This hierarchy in this system reflects the amount of data that can be obtained by any code, and not in the effect that any code has on the code below it in the hierarchy, and the interaction between the code level in the hierarchy and its effect on the codes below it. In addition, all codes and the hierarchy of this system are determined in advance.

The hierarchies in the patents WO2004070550, GB2402840, U.S. Pat. No. 5,021,776 are all built on the same principle, of a central system and/or the Master code/s and/or programming code, and below them a limited amount of code levels whose power decreasing according to ranking in hierarchy.

In all those patents only the central system and/or master code/s and/or code programming are those issuing codes, create levels, erase levels, determine the powers, limitations and options granted to each level and a specific code, and only they are the ones that can change the code.

As a result, in many situations the use of these methods is not friendly enough, because of the limitations they create.

Also, the hierarchy in all these methods is also a hierarchy of choices—as higher the code in hierarchy its strength is greater. While many times it is actually necessary to give more choices to codes at lower levels.

The method of this invention comes to solve these problems and many others. With an easy, comfortable and friendly using.

### SUMMARY OF INVENTION

The invention is about a multi-level combinational code lock system in which there is no predetermination how many levels will be and how many codes will be at any level.

The first code will be set its code by itself. With the setting of the first code the code owner can create below it a level or levels of codes, and at every level to create a lot of codes.

Anyone who has received from the owner of the first code an access code to the protected place and was not restricted, can operate independently and create below it level or levels and in every level to create how many codes he wants. Any one who has received a code from the code owner at the second-level code, or at the third-level code (who received the code from the code at the second level), and so on, at any level, regardless of what level issued its code, can create levels and codes below.

According to this method when there are parallel codes at the same level, a chain of separate levels is created from each code. Without restriction to the length of the levels chain and the amount of codes in each level, and there should not be overlap between the length of levels chain and/or the amount of codes arising from any of the codes at the same level.

All operations can be carried out in the code locking system itself in a regular use, regardless of external systems. Also determining the actual code (the code numbers, or any other form of code) by those who created it or replace it, can be made in the code locking system itself. Accordingly, all the code are different, including the codes at the same level, each is different from the others.

Every code, even at the lowest level, can have total or limited control on the levels and codes that lower in the hierarchy, in accordance with authorizations and restrictions. Control of the code on any level, can include adding, deleting or changing levels and codes (the numbers, or anything else that is used as code), and limit the rights of use and the possibilities of action of the levels and codes at lower levels. In that way the high-level control includes control over the level of service and the options of actions of the level beneath it. It is also possible to change, cancel and limit the highest code, or to add additional code level above it, or a code parallel to it.

Hierarchy does not have to be either about the rights of use and the possibilities of action. It is possible to provide all levels the same rights of use and possibilities of action, and can also limit level or code in restrictions that do not apply to the levels and codes at lower levels, even the limits that apply to the levels and codes that the code itself creates beneath it. So it is possible to give rights of use and options of actions with no limitation to selected codes each of which can be on a different level, and at the same time limiting the rest of the codes in those levels, and in higher or lower levels.

Accordingly, for example, it can be set that only low-level code can open the protected place, and the codes at the highest levels can not open the protected place, and the role of high-level codes will be to control the lower levels.

As a result, this system allows easy use of many options, such as adding, deleting, changing, authorization and restriction of levels and codes.

The invention can be implemented using the existing type of a key pad or of touch screens or any form typing a code.

The invention can be applied for any system requiring an access code. It is possible also to implement the invention in the system that existing with minor changes.

### BRIEF DESCRIPTION OF THE DRAWINGS

FIG. 1 is a perspective view of the combination lock 20. From FIG. 1 it is possible to identify the standard combination lock 20, and its relevant buttons 21 and its screen 23. In addition it is possible to identify the code button 24 and the enter button 25.

FIG. 2 is a top view of the combination lock.

FIG. 3 is a description of a hierarchical lock system where one system controls the other system.

FIG. 4 describes a simple single code, 4 levels hierarchical lock.

FIG. 5 describes a simple multiple code, 4 levels hierarchical lock.

### GENERAL DESCRIPTION

The system is a multi-level coding system.

There are several ways to key in the codes and control the system, one implementation example will be described here, but hierarchical lock system can be implemented in many ways.

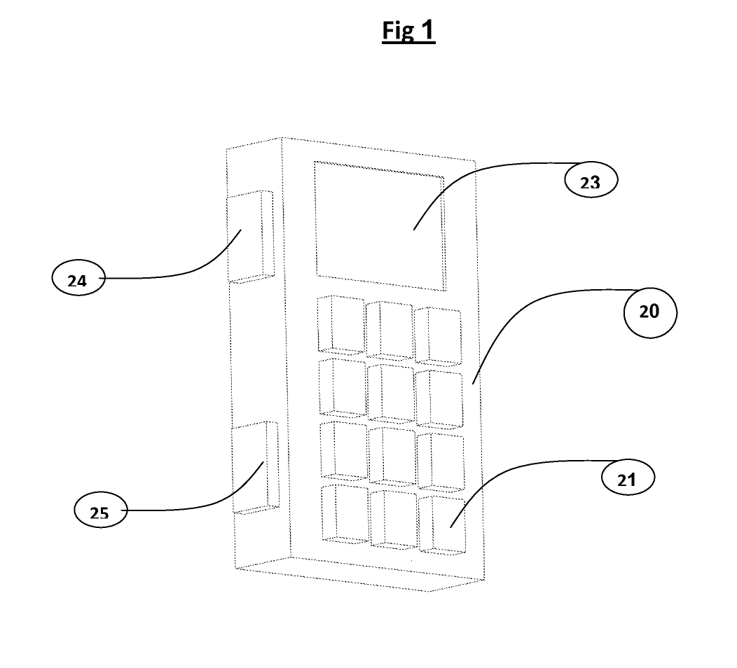

FIG. 1 is showing a key pad system Key pad 20 will have keys 21, screen 23, a code 24 key and enter 25 key.

This example describes a code lock system which has one unit or two units (or more) which in its mobile part there is a keyboard. Of course any other code lock system can make the same operation according to the data. For example using keyboard or a touch screen in front of the driver in a car.

Also, as shown in this fig all actions can be carried out in the code lock system itself regardless of external systems. Including determination of the code itself (numbers, or any other form of code), replacing, adding or eliminating code and setting limitations and removing them etc. In this example, the software, memories, etc. are in computing system of the code lock system itself, and any instructions and actions will be done by the same way in which entering or transmitting the access code-opening code.

You can also allow to perform all or part of operations through a network, wired or wireless remote communications and Internet, or in any way you can transmit to the computerized system of the code lock. To allow the options of control even for someone who is far from the protected system.

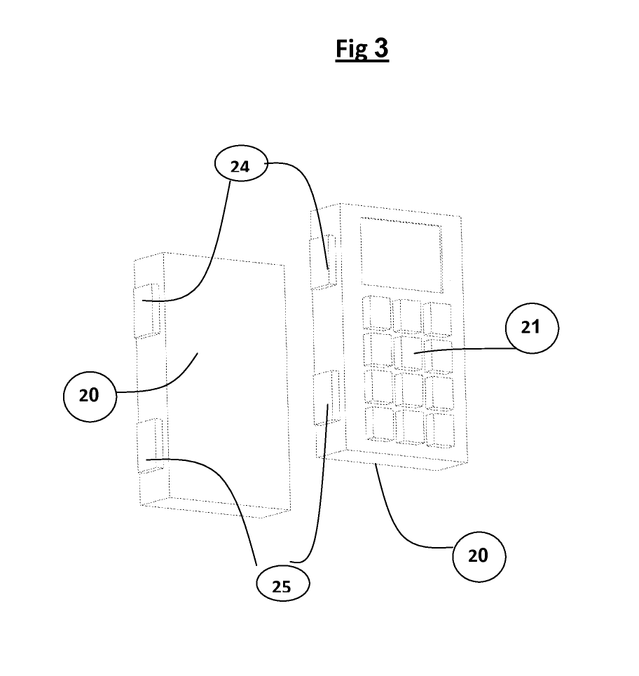

It is also possible that the central computerized system will not be on the code lock system itself, but through network, and so on, or that one system will rule on another system, as shown in FIG. 3.

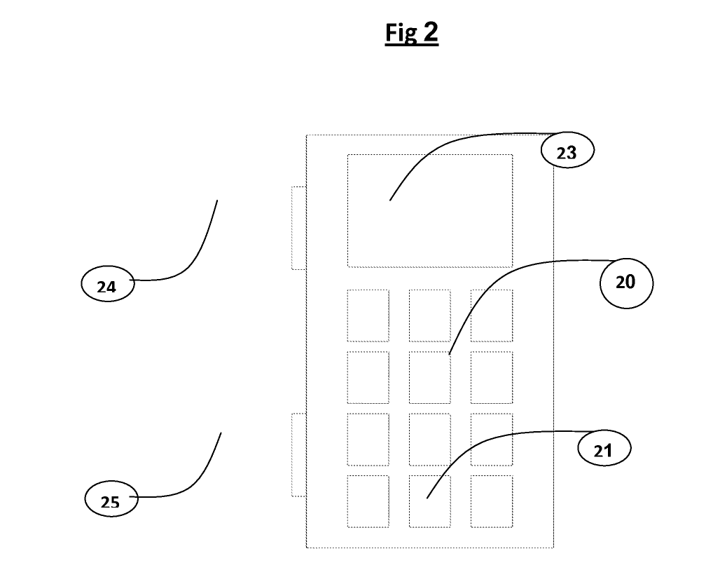

FIG. 2 is showing the key pad from a top view.

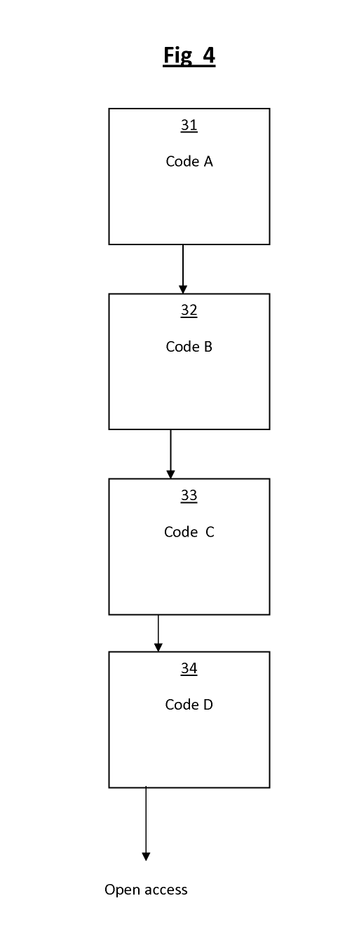

FIG. 4 describes a system with one code in each level.

The code in the highest level creates a code in level B and can control and change it.

The code in level B creates a code in level C and can control and change it.

The code in level C creates a code in level D and can control it and change it.

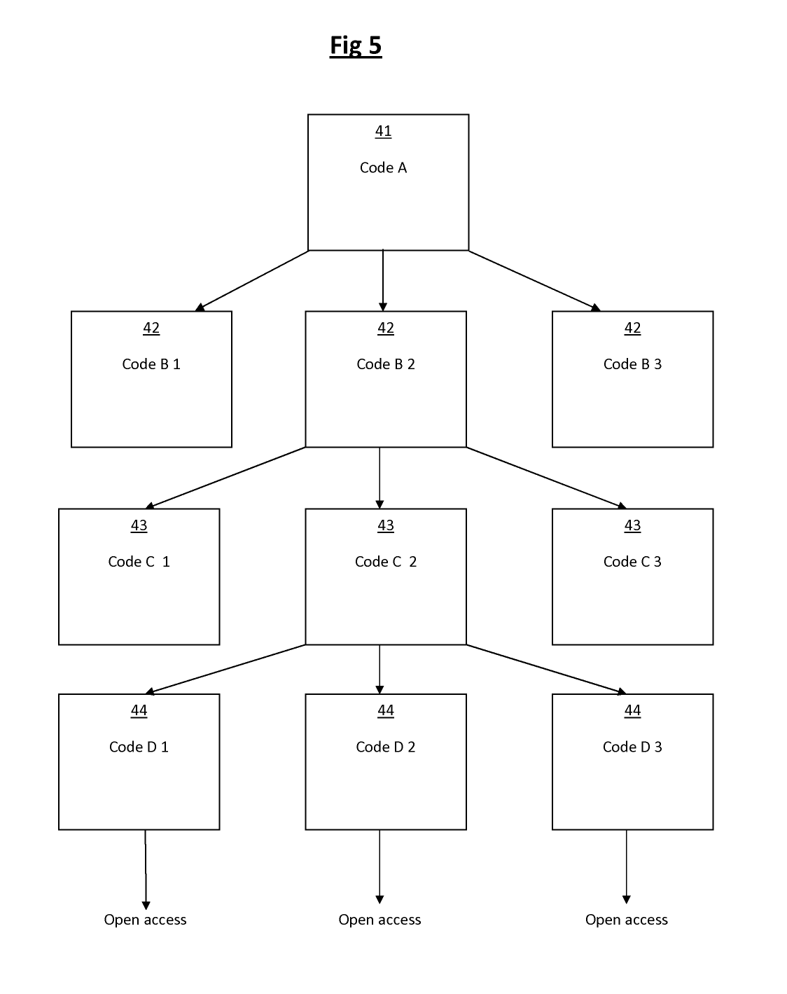

FIG. 5 describes a system with multi codes per level. In this example, 3 codes per level and one code in the highest level. The code in level A creates 3 codes in level B and can control and change them.

B1 and B3 are each controlling several codes not shown in the figure. B2 in this example is controlling 3 codes in level C, C2 is controlling 3 codes in level D, each of which can open the access to the protected system.

As shown in this example when there are parallel codes at the same level, you can create from any code separate chain of levels. Without a limit on the length of the chain of levels and on the amount of codes in each level. There should not be overlap between in the length of the chain of levels and/or in the amount of codes arising from any of the codes, even the codes at the same level.

So it may be that one code at level B will create a chain of levels up to level Z, and from the second code at level B will not be created any chain of levels at all, and from the third code at level B a chain of levels up to level D. It can also be that one code level B will create many codes at level C and the second code at level B will create only one or two code at level C.

Under this example, level D can be controlled both by level C and by levels A and B, but it is an option that every level will only control the level below it, or limited levels below.

It is also possible that some codes will control all levels under them and some do not. For example: When the code at level A creates three codes at level B, it can restrict the code B1 that would not be able to control any level under it, and restrict the code B2 to control only one level below it, and not restrict code B3 at all, and allow it to control all the levels below it.

Furthermore, when the code at level A creates the codes at level B it can restrict level B that all or part of its codes can control only one level lower them, meaning that they have control only on level C or only on part from level C, and not on level D, but all or part from the codes at level C that were created by the limited codes at level B, will not be limited, and they will be able to control all the levels below them.

Under this example, a specific level code can controlling only on the codes that they below it in the hierarchy. Under another embodiment, every code in a certain level can controlling all codes in the level and/or in the levels below. And it can also be determined that it could control on part of the codes at the level below it and could not control on other part.

It is possible that only the lower level code in this example of code D will be able to open the system. And it is possible that all pyramid codes will be able to open the system. And it is possible that some codes will be only control codes, and other codes or codes of a certain level will be also able to open the system. For example, you can set codes from level C code they are also opening codes, and the codes A and B they are only control codes. Or codes at level A and C will not be able to open the system and codes in level B and D will be able to open it.

Of course, in case the restriction is that only the lowest-level code can open the protected system, the system will not check what is the lowest level that exists in the system, but what is the lowest level in this chain of levels.

So it is possible that in a chain levels that arise from one code that the lowest level will be level Z, and from other code it will be level B.

Under this embodiment, one of the codes in the lower hierarchy will be that of the other system. In the example shown if FIG. 5 there are two level B codes—one of them can be assigned to the second system.

It will be possible also to change the highest code or to zero, cancel, impose restrictions and eliminate restrictions apply on it. It is also possible to have an option to add a level above the highest code or add code parallel to the highest code. Each of these options can be performed by one of three options the system will be programmed to:

1. Press only the highest code itself (code A).
2. Press the highest code itself (code A) and the code under it (Code B) [in case there is some codes in level B, will need to determine in advance if necessary to press them all, or have prior choice of one of them, or have enough press one of them without a prior choice].
3. Any action in the highest code will require a technician intervention.

It will be possible to use the options above in case of transferring ownership in a way that the new owners can be sure that all levels and codes were completely eliminated, and can start all over again.

It is possible that the high level code is only reset the lower level code and the user in the lower code can determine for himself any code he wants. It is possible that the higher level code do not know the code that the low code owner has set himself, and every access to the protected system by other code will reset the code again, and can restrict access from it to the protected place. For example, guest get a hotel room, the reception reset the code to his room, and he sets himself the code. The reception will not be able to know the code he set. And any access to the room by other code will reset the code again, and he could not get access to the room (he will have the ability to give permission to enter, as noted below). Thus, it will have an indication of any unauthorized entry to the room.

The hierarchy will be built with the first code entry—the highest—at level A (it is possible to be give another name to this level). Code A will be entered by the code owner itself.

The code owner at level A code can create under it a level/levels as needed, and at every level to generate codes as needed.

Every code owner at level B (or any other level) that was created by level A can create under it level/levels and codes as needed.

Every code owner at level C (or any other level) that was created by level B can create under it level/levels and codes as needed. And so on, all those who have access code to the protected place, in any level, regardless of what level his code, and what is the level that created it, as long as it is not limited, can create under it level/levels and codes as needed.

It is also possible that before setting the highest code, it will be possible to create temporary codes not included in the hierarchy, and they will be canceled automatically with a fixed code setting. For example: vehicle manufacturer and marketers will be able to set temporary codes until the transfer of the vehicle to the buyer.

You can also enable to generate codes in a lower level before determining high-level code. In the example above, in a company where the worker gets the car from the dealer and not the boss, the worker can create for himself now a code in the second or third level. When the car arrives to the company the manager will generate a code at the highest level preserve only for him, and he will be create codes at the lower levels.

As any code can create levels and codes in the levels below it, so he can control the levels and codes below it.

The control of codes in a certain level allows:
1. Adding a code
2. Deleting a code
3. Changing the name of a code
4. Changing the code.
5. Enable code change. It is possible to allow that the code in the high level only just reset the code that from underneath and the user in the low level more will fix its code.
6. Changing the hierarchy. It will be possible to add or delete levels in the hierarchy.
7. Setting and changing code priority. Different people may have different levels of usage—one can have a free use of the car and the technician fixing the car only 10 miles of drive, limiting the number of usages and the time of usage. Any limiting code can generate codes with the given limitation but potential narrower rights (is the upper level allowed access for one day, the lower level may limit it to 2 hours on this day).
By the same token it is also possible to limit the number of times it can be used with this code.
However, it is also possible that this limitation will not be applied also on the codes that the limited code will generate as follows.
There will be also an option for every code to allow others access to the protected place even without a code, with a predetermined action such as entering key or card, or no action, with limitations as limitations of time, a number of activities etc., or without any limitations, in accordance with authorizations and restrictions.
For example, a computer user will be able to determine when he types a certain code, the computer technician can log onto his computer without a code (of course it could be with limitation on the operating time and on the number of entries).
Another example, a guest in hotel can determine that when a code is entered the room server can insert a card issued by the hotel and enter the room (of course it could be limited to the time and number of times etc.).

It is possible that the high level code can cause restrictions on the code below, to not have the authority to control the codes or levels below, in general or partial.

And it is possible to restrict certain level or code, in the number of codes that they can create. For example, a garage manager can get a code with a restriction to issue only one code for the garage worker.

You can also set a limitation for a particular code and determine that this limitation does not apply to code it generates level below it. For example: You can set that code B can not receive the list of codes below it, and code C that the limited code B itself created can get them. Or code B will be limited in the number of codes that it can create, and the code C that the limited code B itself created will not be limited in that.

It is possible also to limit the authority of the code to be only up until it generate another code below it.

In any case the limitation defines the activity of the code to time, distance traveled, or until the creation of another code below it etc., the completion of the limitation automatically terminates the authorization of the code and it is canceled.

And if he had permission to create code below it without the same limitations, or without some of the limitations or no limitations at all, the code under it will continue to function in accordance with authorizations despite that the code that created it was canceled.

For example, an employee in a leasing company can have a code with limitation on time, distance traveled, on the possibility of receiving the report on the levels and codes of below it, and on the possibility to issue only one Code. The code that creates the employee to the car renter will be code without limitations.

In other words, anyone who is authorized to create a code (and is not limited) can be empowered to set limits on the same code (or on the same level as a whole). And determine how to apply this restriction, if of all codes that lower from it in hierarchy, or only on all the levels and codes that derive from this specific code, or only on part of levels and codes lower from it in hierarchy or derive from it, or only of this specific code.

Possibilities to impose limitation can be specific to each code, and can to include levels or groups of codes. Also, you can impose any limitation specifically, and can impose groups of limitation that deal with one subject or various subjects.

The following description is an example of how such functions can be implemented. To gain access to the protected place the code owner will have to enter the code.

It is possible to demand to press also the code name, meaning—the level and number of code at the same level, for example—B2—123456.

This option would help reduce the problems that can arise if the same code (for example: the same numbers) will determine two different codes, especially if they will not be at the same level or restrictions apply to them will not be equal. For this method anyone who creates a code also sets the code (and not the system), which in this case may determine same code numbers for different people.

Because this solution does not answer the problem in the case of determining two overlap codes at the same level, it is also possible to require code name and code name who created it, for example C4 code generated by B2 code will enter C4B2—123456. You can also require all the codes he derives from them, but in many cases such a requirement is not practical.

It is also possible that it can be set to any level and any code specifically how it would have an access to the protected place.

In some cases you can also use the method that the system will notify those who want to create code that already exists in the system, such “code exists”. However, this method must be used in a very limited way, since it is very possible the message that such code exists will allow anyone who is not authorized to use it.

The method of the entering the code name and the code name that created it, or press all the codes he derives from them can also be used in other cases. For example, if in order to cancel or change code will need to enter the code name, and there are several codes with the same name, and also when you want to add code to the existing codes, and so on.

The following description will show how an owner of a code at a higher level can control the codes at lower levels.

This disclosure describes system activation by pressing buttons—but there are of course many other ways to enter a code or control a system.

For example: touch screen, magnetic card or wireless card (RFID), wired or wireless phone, or any other device on which you can click and/or in which you can transmit the access code—opening code. And using anything connected or can be connected to the computerized code lock system wired or wireless, as a keyboard or touch screen before the driver, wired or wireless communications, and the like.

In the example shown in FIGS. 1 and 2, before any control action on lower levels and codes, the user clicks on button number 24 and then enter the code, and then click the enter button number 25.

A menu will appear on the screen, it will show all the action option listed above. But it will be possible to do all these without the screen, by pressing keys or special codes for Action.

On the menu that will appear on the screen first will appear just different options as headings, and when one option will be chosen sub screens will appear and it will be possible to determine the details on them.

First on the sub-screens will appear the main actions that need to be performed, for example, selecting “Change Code” will open a sub-screen where the user specifies a code he wants to change and what is the new code. In some options may be several stages, for example: When selecting “Cancel Code”, after the main phase of the operation will open sub-screens matter which will determine whether all levels and codes arising from it will be canceled or only some of them, and what part, or only this code is canceled, without affecting other levels and codes. Also when setting or removing restrictions will open other secondary screens to determine whether this decision will also affect all levels and codes arising from this Code or just on that code, or on some of them, and some parts and which parts. And so on.

There will be an option that every code be able to get a view on the display of all the levels and of the codes below him. This option can also be dependent on the authorization or limitation, so only code with special authorization or code with no limitation can get all the codes levels below it, or a certain part of them. It will be possible also to give authorization or to assign limitations to certain times or certain conditions.

It is possible that the upper level will be allowed to do any act in the lower level only if he knows the lower code or the name, and it is possible also to demand from the user both.

But it is possible to give also option that the upper level will be able to do an action every that she in the lower code also without knew the code in him he wants to do a change or his name, in certain situations it can be vital.

In every adding or changing of a code or a level it is possible that the name is automatically determined by the system. And it is possible the creator or changer of the code or level will determine their names at will. The creator or changer of the code or the level can determine the name at will, according to the hierarchical order or not in order, and also in other marks. However, in any case the name is not determined by the system, it will needed to get approval from the system where it does not correspond other name of a level or a code already exist.

In the case of adding a level above the highest code or canceling the highest code level, or when adding or canceling a level between two levels, and the like, can be determined if in result of the addition or cancellation will change automatically the names of all lower levels in the hierarchy, or the addition or cancellation will not affect the names of the other levels, and the extra level will get a different name.

There will be a control software which will register the hierarchy.

In any case of addition or cancellation of level until special authorization or limitation will be set, the control on the levels and codes lower than the changed level or canceled level according to the new hierarchical order.

It is possible that every action will end with pressing the enter button.

It is possible that approval will be required at the end of any operation change made.

It is possible that all these activities will be allowed to a code for the codes below it only after pressing a specific key or a specific code to enter to the system.

It is possible that before a code can get into the system to any action on the levels and codes lower from him, it will be necessary to press a key or press a certain code. But it is also possible to allow to reach the same results with a waiver of some of the processes mentioned above.

It is possible to have some connected locking systems in which will be given different permissions to different codes. For example: at home, may be some locking systems, one at the gate of the courtyard, the second at the entrance to the house, and the third at the entrance to the parents' bedroom. Codes will be given to certain people with permission to open only the gate of the courtyard, family members will be codes with permission to open the house, and the parents code will unlock all locks even the parents' bedroom.

It is possible that some of the restrictions will be default, with the option to change or not, or some levels or some codes will be able to change them and some do not.

It is possible, create a record of all activities and changes in the system. With the granting of permission for certain codes to receive a report of all actions. The program can be designed to send the details by different applications, such as wireless connection, direct connection to the combination lock, or represent a report on the existing screen.

It is possible also, that every action will show on the screen during its operation. And an option not to show it, always or at a certain time.

It is possible that actions every that they will serve as a substitute and/or shortcut to the codes.

Hierarchical system described above can be also applicable those parts of the system they operate without code, and systems that do not work at all with codes.

For example, a system that all or a part from it operates according to biometric data, fingerprints, facial recognition, voice recognition, and so on. Systems that operate by identification card, or any other way.

Also, the hierarchy described above can be applied not only on the locking system but on every computerized system.

This disclosure is meant for the description of a general concept.

The systems, processes and methods described above are just examples on how to get to the desired results. The examples described it may be possible to get to the same results using other systems or methods. The examples given were for the purpose of the ease of understanding of the method and should not be limiting the concept in any field, state, place or time, not to certain devices or operations.

It is not meant to limit the invention to any specific implementation, and there are many potential implementations of this described concept.

He claim:

1. Hierarchical code locking system, where the code locking system work with a hierarchical code system, where anyone who has an access code (at any level) to the protected place can add underneath while using levels and codes, the hierarchy of levels that was created has a hierarchy of control in which each code can control on the lower levels in the hierarchy, so you can add, cancel, modify and limit each level and each code, and even the top level, and all the actions can be performed independently by each user of a code by the locking system itself regardless of an external system.

2. System as claim 1 in which no predetermination how many levels will be and how many codes will be in each level, when setting the first code the user can create below it level or levels of codes and in each level to create codes as needed, all who received from him, or from a source at any level code access to the protected place, no matter what level issued its code and from what level received his code issuer the code, as long as the code is not limited it can operate independently and create level or levels below it and in each level to generate codes as needed.

3. System as claim 1 which can be created under each of the codes at the same level chain of separate levels and codes, without limitation on the length of the chain of levels and number of codes in each level, and without any overlap between the entire length of the chain of levels and/or the amount of codes arising from any of the codes at the same level.

4. System as in claim 1 in which the control of the code on the lower levels, includes: adding and deleting codes and levels, changing levels and codes and their names, and limiting the rights of use and choices of actions of the levels and codes, and eliminating the restrictions.

5. System as claim 2 or 4 in which the owner of the first code can set the code by himself (the numbers of the code, or any other form of code), and all the other codes are set by anyone who create or replace the code, and for each user can be set a different code than the rest, even the rest of the codes generated by the same code to other users on the same level, and in case of trying to create a code that already exists in the system the system will have option to alert.

6. System as claim 2 in which the name of level or code is automatically determined by the system, or by the creator of the level or code, according to their position in the hierarchy or any other determination of the creator of the code, in accordance with authorizations and restrictions of each level and each code.

7. System as claim 1 in which can all actions be done in code locking system itself regardless of external systems, so the software, memories, etc. will be in the computer system which is in the code locking system itself, and all the commands and actions will be taken using the same keyboard, touch screen, magnetic card or wireless card (RFID), or any other device on which you type and/or which you transmit the access code—opening code, and also using anything connected or can be connected to the system's computer code locking system by wires or wireless, such as keyboard or touch screen before the driver in a car and the like, remote communications and Internet or any way you can transfer to the computer transmission of the code locking system.

8. System as in any one of claims 1-4 where the hierarchy does not have to be either about the rights of use and possibilities of action, and can provide all levels the same rights to use and possibilities of action, and it can also limit level or code with restrictions that do not apply to the levels and codes at lower levels and even with limits that do not apply to the levels and codes that created by the limited code itself.

9. System as in any one of claims 1-4 when code can determine about the levels and codes below it whether they will control only the levels and/or codes derive from them, or they will control all levels and codes on lower levels, including levels or codes that do not derive from them, and the determination can be generally or individually so there will not have to be an overlap between the determination about the level or code on each other, even if they are at the same level even if they derive from the same source.

10. System as in any one of claims 1-4 when code can determine on level and code below it generally or individually, whether he will have full control over levels and codes below it, or the control on levels below it and code will be limited, in general or partial, on the levels and codes sequentially and non-sequentially, as regards limiting the possibilities to create and/or control the levels and codes, and limiting its control of certain things or to certain things.

11. System as in any one of claims 1-4, in which limits that code can create on the levels and codes below it include the possibility that the code will be canceled automatically after ending of restricted permission of distance, time, hours of operation, a number of accesses to protected place or when setting other code below him, and all other possible restriction.

12. System as in any one of claims 1-4 in which the permissions and limitations that a code can determine on the levels and codes below it, can be general and can be on one level or code, or on some parts of the levels and codes by his choice, regardless of the permissions and restrictions that apply to other levels and codes from higher or lower levels, and regardless of permissions and restrictions that apply to the rest of the codes in its level whether they derive from different codes and whether they derive from the same code.

13. System as in any one of claims 1-4, in which you can limit code with all the limitations and to allow this limited code to create below it unlimited levels and codes and according to that you can limit some of codes to not have physical access to protected system (Open, etc.) and their role will be only to control the codes below them, and this limited codes will create codes that will have access to the protected system, no matter where they are in the hierarchy and on the options given to the codes above them, underneath and parallel to them.

14. System as in any one of claims 1-4, in which you can set permissions and restrictions in general or specifically to each level and code whether the control on the lower levels and codes will be possible even without knowing the name of a level, the name of the code and the code itself, or the control can be accessed only by knowing the name of a level, the name of the code and the code itself or by knowing one or some of them, according to the permissions and restrictions.

15. System as in any one of claims 1-4, in which when canceling level or code, it can be determined either by the cancellation will also be canceled all levels and codes derive from him, or just the same level or code will be canceled and levels and codes derives from him will continue to work with the control of higher levels that have left, according to permissions and restrictions.

16. System as in any one of claims 1-2 in which code can add a level or code instead of level or code below it that were canceled, and also add a new level or a new code between two lower levels which already exist, and as long as no permissions and special restrictions will be set the status of the new level or code will be as the other levels and codes according to their location in the hierarchy.

17. System as claim 1 in which you can allow to change the code in the highest level, cancel it and impose restrictions etc. or add code above it or parallel to it by typing the highest code itself, or by typing the highest code itself and the code below.

18. System as in any one of claims 13-15 in which when adding or canceling code level can be determined whether the names of the lower level in the hierarchy will change, or the addition or cancellation will not affect the names of the other levels.

19. System as claim 1 in which are stored in memory all levels and codes and their names, as well as all actions committed or attempted, including any access to the protected place, cancellation and change of levels and codes, restrictions or their cancellation, with details on the source of action and timing, and it will be possible to able any code or some codes to get all information relating to and/or to lower levels, or part of them, in accordance with authorizations and restrictions applicable to each level and code in general or specifically, both for each level or controlling code and for each level or controlled code.

20. System as in any one of claims 1 and 5, in which when creating a new code can create a reset code and the user of the new code will decide for himself the code (the numbers of the code, or anything else that will be used as code), and also when changing the code it will be possible to reset the existing code by code at a higher level, and the user will set his own new code.

21. System as claim 20 in which it will be possible to determine that any access to the protected system by other code, will reset the code again.

22. System as claim 1 in which before setting the highest code it will be possible to create temporary codes that do not include in the hierarchy and will be canceled automatically when determining a fixed code, or set a code at a low level before setting the highest code.

23. System as claim 1 in which by entering a code will be allowed to access the protected system without a code with a predetermined action such as introducing key or card, or without any action, with limitations as limitations of time, a number of activities and the like, or without any limitations.

24. System as claim 1 in which a particular action will be used as a substitute or shortcut to codes.

25. System as claim 1 in which you can perform any action through a network or any form of communication and remote control.

26. System as claim 1 in which one system can control another system.

27. System as in any one of the preceding claims 1-26 in which the protected systems are house, car, office equipment, a safe, a website, or any other place that is using access code or other means of identification for protection by code locking system or by any other system that uses a computerized identification.

28. System as in any one of the preceding claims 1-27 in which all or part of the hierarchical system is not turned on by codes but by other means of identification, such as biometric data, fingerprints, facial recognition, voice, smell, etc., identification cards, or any other means of identification.
